(19) United States
(12) Patent Application Publication
(10) Pub. No.: US 2021/0339925 A1
(43) Pub. Date: Nov. 4, 2021

(54) HIGH-BARRIER RECYCLABLE FILM

(71) Applicant: BEMIS COMPANY, INC., Neenah, WI (US)

(72) Inventors: OTACILIO T. BERBERT, Oshkosh, WI (US); Zheng Tian, Neenah, WI (US)

(21) Appl. No.: 17/286,295

(22) PCT Filed: Nov. 30, 2018
(86) PCT No.: PCT/US2018/063487

§ 371 Date: Apr. 16, 2021

(51) Int. Cl. B65D 65/40; B32B 27/08; B32B 27/16; B32B 27/30; B32B 27/32; B32B 7/12

(52) U.S. Cl. CPC B65D 65/40; B32B 2307/31; B32B 27/16; B32B 27/308; B32B 27/32; B32B 7/12; B32B 2250/24; B32B 2255/10; B32B 2255/26; B32B 2307/308; B32B 2307/7244; B32B 2439/70; B65D 2565/385; B32B 2307/718; B32B 27/08

(57) ABSTRACT

Disclosed herein are high-barrier recyclable films for packaging having a composition of at least 95% polyethylene. The film is comprised of an oriented and annealed base film, a sealant and a barrier material between the base film and the sealant. The film can be used for high-performance packaging applications, providing good appearance and high barrier.

### TECHNICAL FIELD

The present disclosure relates generally to films suitable for primary packaging for products that require high barrier such as food, beverages or pharmaceuticals. Specifically, this disclosure relates to high-barrier films that are considered recyclable and have improved heat resistance properties. Packages made from the high-barrier recyclable films are also provided.

### BACKGROUND

Many consumers and consumer goods packagers desire to use recyclable food packaging. In some cases, recyclable packaging structures are desirable for compliance purposes. High performance food, beverage and medical packaging typically use oriented polyethylene terephthalate (OPET) or biaxially-oriented nylon (BON) for outer layers, which provide high stiffness, printing quality and heat resistance. Without any additional compatibilizing chemicals, however, both OPET and BON are not recyclable in current recycling streams.

Additionally, packaging used in applications that require high barrier often utilize materials such as PVdC (polyvinylidene chloride) or EVOH (ethylene vinyl alcohol copolymer). These materials are also challenging to recycle without the addition of compatibilizing chemicals. These materials are generally not accepted by recycling processes.

It is understood that a polyethylene structure is a way to provide recyclable films. Polyethylene structures typically have low stiffness, limited heat resistance and provide moderate to low barrier. The completed packages tend to fall short of the expected characteristics for high performance packaging. Poor heat resistance and durability results in poor appearance due to shrinking and scuffing. Barrier performance may not meet expectations due to lack of high-barrier materials and poor heat seals causing non-hermetic packaging. To improve the performance of polyethylene structures, some polyethylene films of the prior art are oriented but continue to exhibit drawbacks with respect to heat resistance and stiffness.

There is a continuing need for films that are recyclable while also providing excellent mechanical properties, high barrier and heat resistance to meet the demands of high-performance packaging.

### SUMMARY

A high-barrier recyclable film having a base film, a barrier material and a sealant as described herein provide for an improved recyclable package having properties to run on high-speed packaging equipment, create hermetic heat seals, survive distribution, maintain good appearance and maintain low transmission levels sufficient for demanding applications such as food, beverage, pharmaceutical or industrial packaging.

A high-barrier recyclable film comprises a) a base film, the base film being oriented, annealed and cross-linked, b) a sealant, and c) a barrier material, the barrier material located between the base film and the sealant. The high-barrier recyclable film may comprise at least 95% polyethylene. The high-barrier recyclable film may comprise at least 97% polyethylene.

The base film may have a free shrink rate of less than 7% in the machine direction and less than 7% in the transverse direction upon application of heat up to 90° C. The base film may have a clarity of at least 85%.

The high barrier recyclable film may have an oxygen transmission rate between about 1×10⁻⁶ cm³/m²/24 hours to about 20 cm³/m²/24 hours. The barrier material may be polyacrylate based and may be present at a basis weight between about 0.016 g/m² and about 3.26 g/m².

In some embodiments of the high-barrier recyclable film the at least 95% polyethylene portion of the base film composition consists of high-density polyethylene, medium-density polyethylene, low-density polyethylene, linear low-density polyethylene, or combinations thereof. In some embodiments, the base film is coextruded and comprises an interior layer comprising medium-density polyethylene, the interior layer positioned between an outer layer comprising high-density polyethylene and an inner layer comprising high-density polyethylene.

Further, the high barrier recyclable film may comprise printed indicia.

Some embodiments of a high-barrier recyclable film comprise a) a base film, b) a sealant film, and c) a polyacrylate based barrier material located between the base film and the sealant film. The base film may have a free shrink rate of less than 7% in the machine direction and a free shrink rate of less than 7% in the transverse direction upon application of heat up to 90° C. The high-barrier recyclable film may comprise at least 95% polyethylene.

In some embodiments of the high-barrier recyclable film, the base film is oriented in at least the machine direction. The high-barrier recyclable film may further comprise an adhesive between the base film and the sealant film. The high-barrier recyclable film may further comprise a primer between the base film and the sealant film.

Some embodiments of the high barrier recyclable film have an oxygen transmission rate between about 1×10⁻⁶ cm³/m²/24 hours to about 20 cm³/m²/24 hours. The barrier material may be in a layer that has basis weight between about 0.016 g/m² and about 3.26 g/m².

A package for a product may comprise any embodiment of the high barrier recyclable film.

A method of making a recyclable package may included 1) extruding a polyethylene to form a base film, 2) orienting the base film in a machine direction, 3) annealing the base film, 4) coating the base film with a barrier material, 5) creating a high barrier recyclable film by connecting the base film to a sealant such that the barrier material is between the base film and the sealant, and 6) forming the recyclable package by heat sealing the high barrier recyclable film. The method may also include irradiating the base film, thereby forming cross-links in at least an outer surface of the base film.

In some embodiments, the high-barrier recyclable film has a base film that is oriented in at least one direction, a sealant film, and a barrier material located between the base film and the sealant film. The base film may have a free shrink rate of less than 7% in the machine direction and a free shrink rate of less than 7% in the transverse direction upon application of heat up to 90° C., and the high-barrier recyclable film may have at least 95% polyethylene.

### BRIEF DESCRIPTION OF THE DRAWINGS

The disclosure may be more completely understood in consideration of the following detailed description of various embodiments of the disclosure in connection with the accompanying drawings, in which:

FIG. 1 is a side view of an embodiment of a high-barrier recyclable film;

FIG. 2 is a side view of an embodiment of a high-barrier recyclable film;

FIG. 3 is a side view of an embodiment of a base film for a high-barrier recyclable film;

FIG. 4 is a graph showing the relationship of apparent shear viscosity and apparent shear rate for cross-linked and non-crosslinked films; and

FIG. 5 is a perspective view of and embodiment of a package using a high-barrier recyclable film.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Films and packaging of the current disclosure are recyclable and provide high barrier to protect the products therein. The properties of the high-barrier recyclable films mimic many of the critical properties of related non-recyclable high-performance packaging films, including heat resistance, good appearance, high clarity, heat stability (low shrink), and low transmission of oxygen, moisture and other migratory species (high barrier). The structures provided have high levels of polyethylene materials and include low levels of barrier materials and other non-polyethylene materials. Portions of the films are oriented and annealed, providing heat resistance and stability. The improved combination of materials and processing described herein provide films with a unique combination of recyclability and performance.

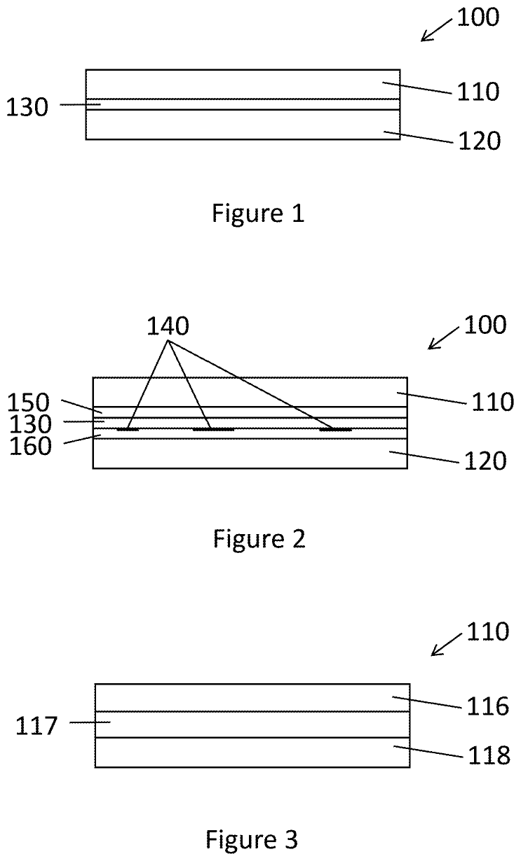

Turning to the drawings, FIG. 1 is a side view of a high-performance, high-barrier recyclable packaging film 100. The film includes a base film 110, a sealant 120 and a barrier material 130 located between the base film 110 and the sealant 120. When used in a packaging application, the film may be aligned such that the sealant 120 becomes the inner layer of the package, in closest proximity to the packaged item (i.e. product) with respect to the other components of the film. As will be described, the film 100 may have other intervening layers or materials. A film having a base film 110, a barrier material 130 and a sealant 120 as described herein provides for an improved recyclable package having properties to run on high-speed packaging equipment, create hermetic heat seals, survive distribution, maintain good appearance and maintain low transmission levels sufficient for demanding applications such as food, beverage, pharmaceutical or industrial packaging.

A more specific embodiment of the high-performance, high-barrier recyclable packaging film 100 is shown in FIG. 2. The film has a base film 110, a sealant 120 and a barrier material 130 located between the base film 110 and the sealant 120. Also included is a primer 150 between the base film 110 and the barrier material 130 and an adhesive 160 between the barrier material 130 and sealant 120. In this embodiment, printed indicia 140 have also been included between the barrier material 130 and the adhesive 160. The printed indicia may be viewable from the exterior surface of the film (i.e. through the base film 110 and barrier material 130) and/or viewable from the interior surface of the film (i.e. through the sealant 120 and adhesive 160).

The base film of the high-barrier recyclable film comprises polyethylene materials. Polyethylene is the name for a polymer whose basic structure is characterized by the chain —(CH2-CH2-)ₙ. As used herein, the term “polyethylene” includes homopolymers and copolymers of ethylene.

There are several broad categories of polymers and copolymers referred to as “polyethylene.” Placement of a particular polymer into one of these categories of polyethylene is frequently based upon the density of the polyethylene and often by additional reference to the process by which it was made since the process often determines the degree of branching, crystallinity and density. In general, the nomenclature used is nonspecific to a compound but refers instead to a range of compositions. This range often includes both homopolymers and copolymers.

“High density polyethylene” (HDPE) is ordinarily used in the art to refer to both (a) homopolymers of densities between about 0.960 g/cm³ to 0.970 g/cm³ and (b) copolymers of ethylene and an α-olefin (usually 1-butene or 1-hexene) which have densities between 0.940 g/cm³ and 0.958 g/cm³. HDPE includes polymers made with Ziegler or Phillips type catalysts and is also said to include high molecular weight polyethylene.

“Medium density polyethylene” (MDPE) typically has a density from 0.928 g/cm³ to 0.940 g/cm³. Medium density polyethylene includes linear medium density polyethylene (LMDPE).

Another grouping of polyethylene is “high pressure, low density polyethylene” (LDPE). LDPE is used to denominate branched homopolymers having densities between 0.915 g/cm³ and 0.930 g/cm³. LDPE typically contains long branches off the main chain (often termed “backbone”) with alkyl substituents of 2 to 8 carbon atoms.

“Linear low-density polyethylene” (LLDPE) are copolymers of ethylene with alpha-olefins having densities from 0.915 g/cm³ to 0.940 g/cm³. The alpha-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). An LLDPE produced with a metallocene or constrained geometry catalyst is often referred to as “mLLDPE”.

Other examples of polyethylene copolymers include, but are not limited to, ethylene vinyl acetate copolymer (EVA), ethylene methyl methacrylate copolymer (EMMA), ethylene-methacrylic acid (EMAA) and ethylene acrylic acid (EAA).

The base film may comprise at least 95% polyethylene. The base film may comprise at least 96%, 97%, 98% or 99% polyethylene. The base film may consist essentially of polyethylene, containing only minimal amounts of non-polyethylene materials that do not materially affect the basic and novel characteristics of the high-performance film. For example, the base film may contain additives such as slip, antiblock or processing aid, as are known by one skilled in the art of film extrusion, for purposes of converting. Additionally, the base film may contain additives such as nucleating agents for manipulation of the physical properties of the film.

The base film may contain material that has been recovered, such as post-consumer recycle (PCR) content or post-industrial recycle (PIR) content. If used, these materials should contribute to the overall material content targets of the film such that they are not detrimental to the recyclability or overall performance of the film.

In one or more embodiments, the base films are 100% polyethylene. The base films may have a composition that is selected from the group consisting of: high density polyethylene, medium density polyethylene, low density polyethylene, linear low-density polyethylene, and combinations thereof. The base films may consist essentially of polyethylene homopolymers of one or more densities. The base films may consist essentially of polyethylene homopolymers, polyethylene copolymers, or blends thereof. The base films may consist of polyethylene homopolymers of one or more densities. The base films may consist of polyethylene homopolymers, polyethylene copolymers, or blends thereof.

The base films may consist of polyethylene homopolymers or copolymers with other materials, such as, but not limited to adhesive, printed indicia and other additives, such that the other materials are collectively less than 5% of the overall weight of the base film. As such, the base film may comprise at least 95% polyethylene. In this case, the at least 95% polyethylene portion of the base film composition may consist of high-density polyethylene, medium-density polyethylene, low-density polyethylene, linear low-density polyethylene, or combinations thereof.

The base film of the recyclable film may be monolayer or multilayer. When the base film is monolayer, it preferably includes HDPE. When the base film is multilayered, preferably a combination of at least a HDPE layer and a MDPE layer is used. In an embodiment, the multilayered base film has the following design: HDPEMDPE/HDPE. In another embodiment, the multilayered base film has the following design: HDPE-mLLDPE/MDPE/HDPE-mLLDPE. In an embodiment, the multilayered base film has the following design: HDPE/LMDPE/HDPE. In another embodiment, the multilayered base film has the following design: HDPE-mLLDPE/LMDPE/HDPE-mLLDPE.

A “layer”, as used herein, refers to a building block of films that is a structure of a single material type or a blend of materials. A layer may be a single polymer, a blend of materials within a single polymer type or a blend of various polymers, may contain metallic materials and may have additives. Layers may be continuous with the film or may be discontinuous or patterned.

Reference to “outer surface” or “outer layer” or “outer film”, as used herein, refers to the portion of a film or layer that is intended to be oriented toward the exterior of a package (i.e. away from the packaged product) when the film is used as a packaging film.

Reference to an “inner surface” or “inner layer”, as used herein, refers to the surface or layer of the film that is oriented opposite of the outer surface or outer layer. In other words, “inner” refers to the orientation away from the outer surface and towards the package interior where the product is packaged.

An “interior layer”, as used herein, refers to a layer that is not exposed to handling and the environment. Interior layers may provide functionality as needed for particular applications. Interior layers may provide structural strength or other performance enhancement. An exemplary interior layer may be a structural layer, which provides one or more of: general durability, thermoformability, puncture strength, resistance to curling, and flex crack resistance.

FIG. 3 is a side view of an exemplary base film 110. The base film of FIG. 3 is a multilayer coextrusion of individual sources of polymer resins or blends of resins. Base film 110 has an outer layer 116, an interior layer 117, and an inner layer 118. The composition of each layer is independently polyethylene-based, without restriction. In a non-limiting embodiment, base film 110 comprises an outer layer 116 comprising HDPE, an interior layer 117 comprising MDPE, and an inner layer 118 comprising HDPE. In another non-limiting embodiment, base film 110 comprises an outer layer 116 comprising a HDPE and mLLDPE blend, an interior layer 117 comprising MDPE, and an inner layer 118 comprising a HDPE and mLLDPE blend. Other embodiments of the base film may have any number of additional layers provided between inner layer 118 and outer layer 116. In one or more embodiments, layers 116 and 118 may have the same composition different from that of 117. Printed indicia may be provided on the inner surface of the base film, which is optionally corona-treated. Printed indicia may be provided on the outer surface of the base film, which is optionally corona-treated.

The base film may be fabricated by any known process or combination of processes. The initial fabrication step should include some form of polyethylene extrusion. Extrusion may be monolayer or multilayer. Multilayer may be achieved through a single coextrusion process, or successive extrusion lamination or extrusion coating operations. Extrusion may be performed on dies that are annular, flat or any other configuration.

A typical blown film process may be utilized to extrude the base film. The resultant annular tube may be collapsed upon itself while still warm, creating a single palindromic structure. Alternatively, the tube can be slit and wound onto two separate rolls. Prior to slitting and winding the films, the film may be oriented and annealed in line, using monoaxial or biaxial orientation in a double or triple bubble process, as is known in the art. Alternatively, the processes of orientation and annealing may be done in an off-line process. Optionally, irradiative crosslinking may also be completed either in-line with extrusion or off-line and either prior to or after orientation.

The base film may be extruded in a flat die configuration. As with annular extrusion the film may be oriented, annealed and optionally irradiated, either in-line or off-line. Orientation may be machine direction only, transverse direction only, or both machine and transverse direction. When stretching the film in a machine direction orientation (MDO) process, orientation of 2 to 8 times is typical, depending on the film formulation and properties required.

After orientation, the base film should be annealed to reduce the amount of shrink the film will have at heated conditions. Annealing is typically accomplished in-line, directly following orientation, through high diameter rollers heated to temperatures a few degrees lower than the melting point of the polymer or blend of polymers present in the film. However, annealing can be done by any known means including hot air or IR heating.

Reducing the shrink is advantageous for further converting (i.e. printing or laminating) and to improve the appearance of the recyclable film when it is heat sealed in a packaging operation. The base film may have a machine direction shrink rate of 10% or less than 10% upon application of heat less than or equal to 90° C.; or less than 9%, less than 8%, less than 7%, less than 6%, less than 5%, less than 4%, less than 3%, less than 2%, or less than 1%. The base film may have a transverse direction shrink rate of 10% or less than 10% upon application of heat less than or equal to 90° C.; or less than 9%, less than 8%, less than 7%, less than 6%, less than 5%, less than 4%, less than 3%, less than 2%, or less than 1%. Preferably, the base film has a machine direction shrink rate of less than 7% and a transverse direction shrink rate of less than 1%, when exposed to heat less than or equal to 90° C. Preferably, the base film has a machine direction shrink rate of less than 5% and a transverse direction shrink rate of less than 5%, when exposed to heat less than or equal to 90° C. The base film may have a shrink rate of less than 2% in the machine direction and 0% in the transverse direction when exposed to heat of 90° C. The base film may have a shrink rate of less than 1% in the machine direction and 0% in the transverse direction when exposed to heat of 90° C.

As used herein, the term “cross-linking” refers to the chemical reaction which results in the formation of bonds between polymer chains, such as, but not limited to, carbon-carbon bonds. Cross-linking may be accomplished by use of one or more chemical agent which may include, but is not limited to, peroxide, silanes and the like, or by ionizing radiation, which may include, but is not limited to, high energy electrons (i.e. electron beam (EB) treatment), gamma-rays, beta particles and ultraviolet radiation. One method for determining the degree of “cross-linking”, e.g., “cross-link density” or the amount of radiation absorbed by a material is to measure the “gel content” or “gel density”. As used herein, the term “gel content” refers to the relative extent of cross-linking within a polymeric material. Gel content is expressed as a relative percent (by weight) of the polymer having formed insoluble carbon-carbon bonds between polymers and may be determined by ASTM D-2765-01 Test Method, which is incorporated herein by reference in its entirety. Another method for determining the relative degree of cross-linking or gel content is with capillary viscometry.

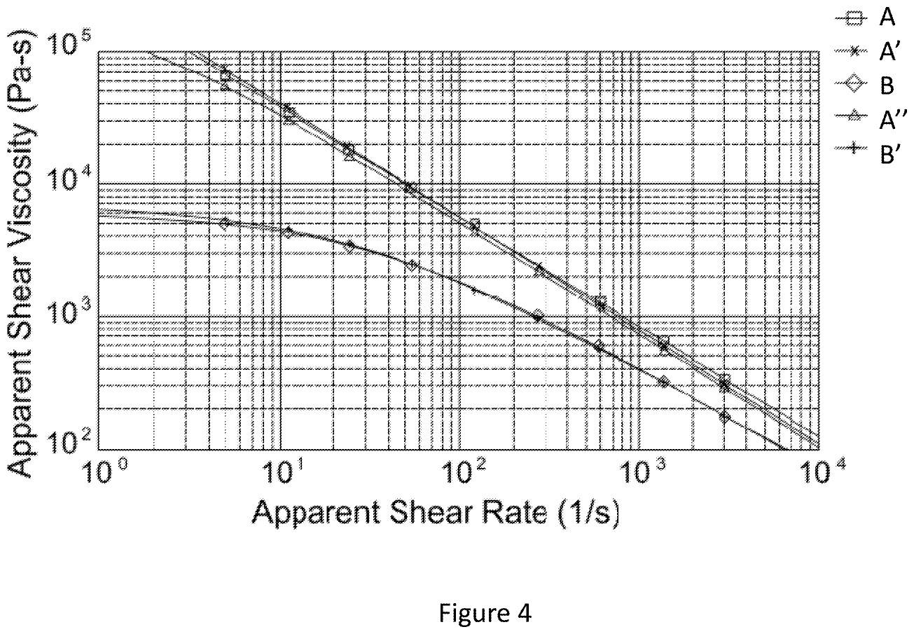

FIG. 4 is a logarithmic graph of gel density comparison by viscosity, showing apparent shear viscosity (Pa-s) versus apparent shear rate (s-1) for film samples that have been cross-linked (A, A′, A″) and film samples that have not been cross-linked (B, B′). For films A, A′ and A″, the change in apparent shear viscosity is substantially constant over an apparent shear rate in the range of 1 s⁻¹ to 100,000 s⁻¹. For the films that have not had an EB treatment (B, B′), the change in apparent shear rate is: substantially flat for apparent shear rate of 100 s⁻¹ and less; a first value between 100 s⁻¹ and 1000 s⁻¹, and a second value between 1000 s⁻¹ and 100,000 s⁻¹. The examples of films that have been EB treated (A, A′, A″) have a cross-link density that is higher than films that are not irradiatively cross-linked (B, B′).

The gel density comparison by viscosity was determined by capillary viscometry. The capillary viscometry was conducted by using a Dynisco Capillary Rheometer, Model LCR 7000, available from Dynisco Polymer Test, Franklin, Mass., USA. The LabKARS software package was used to collect the data. Die number CX400-20 was used at a temperature of 190° C. with approximately 10 g of film loaded into the charging barrel. A melt time of 6 minutes was used before data was collected. Data was then collected at 9 different shear rate points that ranged from 5 reciprocal seconds (1/s) to 3000 reciprocal seconds (1/s). The shear rate points were logarithmically spaced within this range. An additional data point was collected after the first 9 data points to ensure that polymer degradation did not occur with the samples. The additional data point was collected at the same shear rate as data point 5. None of the samples demonstrated any polymer degradation as the additional data point showed similar shear viscosity as that collected at data point 5. The 10 shear rate points that were used, in this order, were: 5, 11.1, 24.7, 55.1, 122.5, 272.5, 606.2, 1348.5, 3000, and 122.5. The software calculated the shear viscosity at the inputted shear rate points.

The base films may be exposed to an electron beam treatment to achieve crosslinking for improved heat resistance. Exposure to irradiation can be from one side of the film, typically the side of the film that will form the outer surface of the package. However, treatment can occur on either side or both sides. The irradiation may affect the polymers (i.e. crosslink the polymers) throughout the entire film thickness or the irradiation may only affect a portion of the film. The irradiation by electron beam may be conducted under conditions of about 2 MRad to about 24 MRad, or any values in between. Conditions for electron beam irradiation may be in the range of about 5 MRad to 20 MRad, or preferably about 9 MRad. Crosslinking is evidenced by improved heat resistance of the film and by viscosity testing of the outer surface of the film as described herein.

Irradiative crosslinking of the film may occur either before or after orientation of the base film. There is some indication that better quality films result from crosslinking the film prior to orientation. However, crosslinking before or after orientation is suitable for the base film.

The base film may have a thickness of between 0.5 mil and 3.0 mil.

The base film may have a clarity of more than 85% or 90%. Ideally, the base film should have a clarity of at least 95%, at least 95.5%, at least 96%, at least 96.5%, at least 97%, at least 97.5%, at least 98%, at least 98.5%, at least 99%, at least 99.5%, or 100%, and all values there between, when measured in accordance with the instructions and teachings of ASTM D-1003-13. Clarity is defined as the percentage of transmitted light that deviates from the incident light by less than 2.5 degrees. The clarity of the base film can be affected by material selection and orientation conditions, as is known in the art. For instance, it is generally known that machine direction orientation of HDPE films to a level of 4-5× will significantly improve the clarity over films that have had less orientation. Alternatively, the base film could be opaque or have any transparency level in between high clarity and opaque.

The base films may have the surfaces treated for various reasons. Corona treatment may be applied to either surface of the base film as may be needed for printing or adhesive lamination. Surface coatings may be added to enhance the slip properties of the exterior surface. Other coatings and treatments may be added to the base film or recyclable film without restriction.

Recyclable films for fabricating packages may include any base film disclosed herein. The base film may be used as an outer film of the multilayer films for packaging and advantageously provide heat resistance during heat sealing. The recyclable films for packaging may be without limit, 2-ply, 3-ply, or more, including multiple base films.

Some embodiments of the high-barrier recyclable film may have a primer 150 applied to the inner surface (i.e. the exposed surface of the inner layer) of the base film 110, as shown in FIG. 2. Primers are generally very thin layers used to improve the surface characteristics of a film, enhancing the bonding or wetting of another layer to be applied. If used, the primer may be applied in either a full layer or patterned to match the barrier material.

There are a wide variety of primers available. The type of primer used should be chosen based on factors such as base film material, base film treatment, barrier material, application technique, intended film use, etc., as is known to those skilled in the art. Testing must be completed to assure that the primer, if used, provides adequate adhesion in the film structure. Two non-limiting options for primers are SunFuse OMNIPRIME WP PP (water based, self-crosslinking) available from SunChemical@ and MICA H-760-A (water based, modified polyethylenimine) available from MICA™ Corporation. A primer may be applied by various processes, such as flexo or gravure printing, smooth roll, etc. A primer may be applied at any coating weight appropriate for performance, typically between about 0.01 g/m² and 1 g/m².

Different than current recyclable films, the high-barrier recyclable films disclosed herein have a barrier material located between the base film and the sealant. The barrier material can be any material that prevents transmission of a migrating component such as oxygen or moisture. Advantageously, the high-barrier recyclable films have barrier levels suitable for providing protection for packaged products that may be sensitive to oxygen or moisture. When used as a packaging film, the high barrier recyclable films slow transmission of oxygen or moisture to help maintain the quality of the product packaged therein, extending the shelf-life.

One example of a suitable barrier material is one that slows the transmission of oxygen. The barrier material, when applied to a film, may limit the oxygen transmission through that film to between about 1×10⁻⁶ cm³/m²/24 hours to about 20 cm³/m²/24 hours (test at 0% RH and 23° C. following ASTM F1927). For many food applications, it is suitable if the oxygen transmission rate of the high-barrier recyclable film is less than 10, less than 5, or less than 1 cm³/m²/24 hours.

Another example of a suitable barrier material is one that slows the transmission of moisture. The recyclable film may have moisture transmission levels of less than 100 g/m²/24 hours when tested at 90% RH and 23° C. following ASTM F1249. The recyclable film may have moisture transmission levels of less than 10, less than 5, or less than 1 g/m²/24 hours. The high-barrier recyclable film may have a barrier material that provides low transmission of both oxygen and moisture.

The barrier material may be applied directly onto the primer, if present. The primer (if present) and barrier material may be applied to any part of the recyclable film structure, as long as the barrier material is located between the base film and the sealant in the final film structure. For example, the primer/barrier material may be applied to the inner layer of the base film, as shown in FIG. 2. In another embodiment, the primer/barrier material may be applied to the outer surface of the sealant (i.e. opposite of the exposed sealing surface). In other embodiments of the high-barrier recyclable film, other films may be present, and the primer/barrier material may be applied to any surface of those films, as long as the barrier material is between the base film and the sealant in the final film structure.

The barrier material may be chosen from a wide variety of coat-able materials. The barrier material may behave like an adhesive that serves to adhere adjacent layers of the structure to each other. The barrier material may be an adhesive. The barrier material must be able to provide the desired barrier level (low transmission rate) at a low coating weight such that the barrier material will not over-contaminate the recycling process. Additionally, certain materials, such as chlorinated barrier materials, may need to be avoided as even small amounts of these materials may contaminate the recycling process.

Non-limiting examples of barrier materials that may be suitable for a high-barrier recyclable film are polyvinylidene chloride latexes (such as Saran™ from Dow), polyalcohols (such as Nichigo G-Polymer™ from Nippon Gohsei), exfoliated clay nano composites (such as Sunbar, available from SunChemical), polyacrylate based materials (such as those used on Besela™ high-barrier films, available from Toppan), or inorganic coatings such as aluminum oxide. The most preferable barrier material will be one that does not contain chlorine, has high clarity, provides high barrier under a wide variety of conditions, and has good flex crack resistance. However, any thin barrier material may be chosen to match the performance requirements of the application in which it will be used.

Because most barrier materials comprise no polyethylene, the content of the barrier material in the recyclable film should be minimized such that the total non-polyethylene portion of the film is present at a mass that is less than 5% of the total film mass. Depending on the total composition of the film, non-polyethylene components may be polymer additives (such as slip or antiblock), adhesives, inks, or other components. Each of these sources should be minimized to ease recyclability. The barrier material may be present in the high-barrier recyclable film at mass levels less than 5%, less than 4%, less than 3%, less than 2% or less than 1% of the total film structure mass. In some cases, the recycling process may accept non-polyethylene levels greater than 5%, in which case the mass of barrier material may be higher than 5%.

One preferable barrier material is a polyacrylate based coating. As used herein, “polyacrylate based” indicates that the material has repeating units with the following structure:

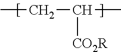

The barrier material may be clear and have good flex crack resistance. The barrier material may be applied at any thickness, as long as the previously described mass levels are met. The barrier material may be applied at any dry coating weight between about 0.01 lb/rm and about 2.0 lb/rm (between about 0.016 g/m² and about 3.26 g/m²) (measured after drying) or any dry coating weight between about 0.1 lb/rm and 0.8 lb/rm (between about 0.16 g/m² and 1.3 g/m²).

The barrier material may be applied in any known method including extrusion, flood coating, gravure printing, slot die coating, etc. Due to the requirement that the barrier material be provided in a very small amount, it is preferable for the barrier material to be coated or printed as these processes can achieve very thin layers. The barrier material can be applied directly to the surface of the base film, directly to the surface of the sealant, directly to the surface of another film, or directly to the surface of any of these material which has been previously coated with another material such as adhesive, primer or ink. Preferably, the barrier material is applied to the surface of a primer which has been applied to the inner surface of the inner layer of the base film (as shown in FIG. 2).

The barrier material may be applied in a continuous layer, co-continuous with the base film, or it may be patterned. The pattern may be invisible to the naked eye. The pattern may apply barrier to certain sections of the film and leave other sections of the film without barrier. The barrier material may be applied in varying amounts such that different areas of the film have different transmission rates. The barrier material may be applied in a continuous layer, providing a consistent transmission rate across the entirety of the film.

The high-barrier recyclable film may be printed with indicia or any have other type of markings applied. The indicia or marking may be applied to the film in any position of the film structure and by any means, such as, but not limited to, flexographic printing or laser marking. The indicia or marking may be visible from either or both sides of the film.

In some embodiments, the high-barrier recyclable film may have indicia that is a result of ink printed by any process typical to flexible film converting, including, but not limited to, flexographic printing, rotogravure printing or digital printing. The indicia may be printed on the exterior surface of the film or may be between other layers and materials of the film. In some embodiments the indicia are between the base film and the sealant. In some embodiments, the indicia may be applied directly to the surface of the barrier material (as shown in FIG. 2) and is visible from both sides of the film.

A sealant may be connected to a base film to form the recyclable film such that a barrier material is located between the base film and the sealant. The sealant may be connected to the base film by any known method including, but not limited to, coextrusion, extrusion coating, extrusion lamination, adhesive lamination or coating.

The sealant may be a film that is manufactured by a process such as, but not limited to, blown film extrusion, and may comprise polyethylene, polyethylene copolymers or blends thereof. One preferable copolymer for sealants is ethylene vinyl acetate copolymer. In embodiments that use a sealant film, the sealant may be attached to the base film by adhesive lamination or extrusion lamination. In either case, there is an adhesive layer between the base film and the sealant film. In some embodiments, such as the embodiment shown in FIG. 2, an adhesive may adhere the sealant to the barrier material and the adhesive may also be in contact with the optional indicia.

The sealant may be a material applied as a heat seal coating. Heat seal coatings are typically thin and may be pattern applied. Heat seal coatings may contain low melt temperature components such as waxes.

The sealant may be monolayer or multilayer. In the case of multilayer material, the surface layer or more than one layer may be intricately involved in sealing. If the sealant is multilayer, it may contain any other materials as long as they do not frustrate the recycling intent for the high barrier recyclable film.

The sealant material should be capable of forming a bond upon exposure to heat and pressure for a short dwell time, a process commonly known as heat sealing. As compared to currently available recyclable films the films disclosed herein have a base film that is heat resistant such that the recyclable film does not shrink or otherwise distort when exposed to sealing conditions. Additionally, the sealant material may soften and seal at a relatively low temperature, further avoiding distortion issues. In other words, when making the heat seal, the heat resistant base film should have high heat resistance as compared to the temperature at which the sealant is capable of making a seal, such that there is an operating window in which the seals can be made without compromising the appearance or other performance properties of the recyclable film.

Heat seal coatings that contain wax components may have heat seal initiation temperatures of 60° C. or even lower. Extruded polyethylene-based sealant films may have heat seal initiation temperatures of 85° C., or even lower. The sealant on the recyclable film may have a heat seal initiation temperature that is less than 60° C., 85° C., 100° C. or less than 121° C.

For some packaging applications, it may be required that the sealant create a seal that is peelable. As used herein, the term “peelable seal” is one that can be opened manually (i.e. by hand). Peelable seals are generally defined by the packaging industry as seals that can be separated by a force of less than 2,500 g/in when measured by ASTM F88. In most packaging applications, a peel strength with a lower limit of about 200 g/in is necessary to ensure that the package does not open too easily, causing accidental opening during handling or distribution. The recyclable films used as packaging may have seal strength less than 2,000 g/in, less than 1,500 g/in, less than 1,000 g/in, or less than 500 g/in.

In some cases, the general composition of the sealant will dictate that the seal is peelable. In other cases, the sealant may be a multilayer film that has several layers that rupture and delaminate to create the peel mechanism, as is known in the art. The peelable feature of this disclosure can be made by any known means.

The sealant may contain material that has been recovered, such as post-consumer recycle (PCR) content or post-industrial recycle (PIR) content. If used, these materials need to contribute to the overall material content targets such that they are not detrimental to the recyclability or overall performance of the film.

Between the sealant and the base film, any number of optional interior films or layers may be provided. For example, there may be an adhesive layer, printed indicia, or a barrier layer between the sealant and the base film. The sealant and any further interior layers can contain recycled materials.

In some embodiments, there may be a second sealant located on the opposite side of the base film from the first sealant. This type of film could be used for packaging applications that require lap seal configurations (i.e. one side of the film is heat sealed to the opposite side of the film).

In general, the term recyclable means that the film is suitable for reuse. An example of one specific context of recyclable is reusing a plastic grocery bag a second time to contain some other items. The plastic bag has been reused and recycled. In a slightly different context, recyclable means that the product is suitable for reuse after being converted into a new product. As used herein, the term “recyclable” is meant to indicate that the film can be converted into a new useful item, by means of reprocessing in a polyethylene waste stream. Reprocessing may entail washing, separating, melting and forming, among many other steps. Typically, when plastic packaging is reprocessed, the material is mechanically chopped into small pieces and then melted to be reformed into the new product. If multiple incompatible materials are present in the packaging, interactions occur during reprocessing causing gels, brittle material, poor appearance and generally un-usable or poor-quality products. Using the term “recyclable” indicates that these drawbacks are generally not present. Qualification as a recyclable material is not regulated by any specific agencies but can be obtained from specific groups such as Trex® and How2Recycle™. Recyclable films disclosed herein may be suitable for “Store Drop-off” recycling streams. These streams may accept the following: 100% polyethylene bags, wraps, and films; very close to 100% polyethylene bags, wraps, and films that have passed recyclability tests by Trex®, and How2Recycle-approved polyethylene-based carrier packing with or without compatiblizer technology. Introduction of a recyclable film into any of these recycling-by-reprocessing avenues should not require additional compatibilizer.

In one or more embodiments, the high-barrier recyclable films are nearly 100% polyethylene. The recyclable films may comprise materials selected from the group consisting of: high density polyethylene, medium density polyethylene, low density polyethylene, linear low-density polyethylene, and combinations thereof. The recyclable films may comprise polyethylene homopolymers of one or more densities. The recyclable films may comprise polyethylene homopolymers, polyethylene copolymers, or blends thereof. The recyclable films may consist of polyethylene homopolymers or copolymers with other non-polyethylene materials, such as, but not limited to primer, barrier material, adhesive, printed indicia and other additives, such that the other non-polyethylene materials are collectively less than 5% of the overall weight of the recyclable film. The high-barrier recyclable film may consist of at least 95% polyethylene, at least 96% polyethylene, at least 97% polyethylene, at least 98% polyethylene or at least 99% polyethylene.

The irradiative crosslinking treatment of, for example, an outer surface of the recyclable film may lead to improved properties relative to a recyclable film with a comparative outer surface of a comparative film that is not oriented and irradiatively cross-linked. For example, the recyclable films are improved such that onset of sticking by an outer surface of the film upon exposure to heat sealing conditions is at least 5° C. to 15° C. higher than a comparative outer surface of a comparative outer film comprising the polyethylene that is not oriented and irradiatively cross-linked. The improvement may be at least 6° C., 7° C., 8° C., 9° C., 10° C., 11° C., 12° C., 13° C., 14° C., or 15° C. higher.

The recyclable films may be used as-formed to fabricate packages. When the recyclable films are used to fabricate packages, the inner surface of the film is of a composition or treated to be a sealant. Printing of the recyclable films may be on the outer surface. For multilayered recyclable films, printing may be on either side of the base film.

A packaging component, such as a lid, can be formed from a high-barrier recyclable film as disclosed herein or a multilayered film that includes the high-barrier recyclable film. In general terms, there is at least a base film, a sealant and a barrier material located between the base film and the sealant. Optionally, one or more additional interior layers may be present between the base film and the sealant.

One method of producing the high-barrier recyclable film includes the following steps. Polyethylene may be extruded to produce a base film which is subsequently oriented and annealed. The base film may be irradiated to induce crosslinking. The base film may be coated with a barrier material and then attached to a sealant such that the barrier material is between the base film and the sealant. The method of producing a high-barrier recyclable film may include other steps, such as but not limited to printing indicia or applying primer.

The high-barrier recyclable films disclosed herein may be used for many purposes but are especially useful for high-barrier packaging applications. The high-barrier recyclable films may be used in a portion of the package or as the entire package. As compared to previously available recyclable packaging films, the embodiments described herein have superior properties in heat resistance and barrier. The high barrier recyclable films can be used in critical high-performance packaging applications that require high barrier to help extend the shelf life of the packaged product. The films also display improved appearance due to the heat resistance, adding to the product appeal at retail points. Consumers desire packaging that looks good and has a good sustainability advantage, such as recyclability. The heat resistance also allows packaging lines to run at high speeds, thus improving efficiencies and keeping costs low.

To form a package, a sealing layer of any film disclosed herein is adhered to itself or another packaging component to form a seam of a package. The recyclable films described herein may be heat sealed to other films to make packages such as pouches, stand-up pouches, flow wrap, liners, sachets or bags. The high-barrier recyclable films may take the form of a lid that is sealed to a rigid, semi-rigid or flexible thermoformed component such as a tray or cup. Packages may further include other components such as labels, zippers or fitments.

It is of common use in many forms of packaging to use heat seals to combine packaging components to form packages. In some cases, packaging materials are sealed to themselves. In some cases, packaging materials are sealed to other packaging components. Packaging components can include, but are not limited to, flexible films, rigid or semi-rigid films, thermoformed pockets such as trays or cups, injection molded items such as fitments, zippers, patches, etc. Hermetic packaging can be formed from one, two, three or more different packaging components.

Hermetic packaging is critical for a wide variety of products, including foods, beverages, pharmaceuticals, consumer goods and other sensitive products. Hermetic packaging can help prevent damage to the product. For many products, achieving good heat seals to create consistently hermetic packages is highly critical. An advantage of the recyclable films disclosed herein is that they are more heat resistant and thus can be formed into hermetic packaging on a more reliable basis. The combination of the high heat resistance of the outer polyethylene base film and the sealant layers that provide quality seals is an important advantage to the high-barrier films presented herein.

It is also an advantage of some embodiments of the high-barrier recyclable films disclosed herein that they are provided with sealants that achieve peelable seals when heat sealed to other packaging components. Packages can be opened by consumers in a number of ways, including peeling open manually. Peelable seals are those that can be peeled open by a consumer by hand, without the use of another tool. A consumer can grasp two parts of a package and pull the package open at a heat seal. Peelable seals allow for the product within the package to be easily accessed by the consumer. In some cases, peelable seals can also be manually reclosed and resealed.

The high-barrier recyclable films may have peelable heat seals to allow for easy separation of the packaging components. This advantageously allows for proper disposal of the packaging components into other recycling streams or waste streams.

Packaging made from the high-barrier recyclable films described herein is suitable for containment of many goods, including those sensitive to oxygen and moisture, or other applications where long shelf life is desired. Products advantageously packaged in the high-barrier recyclable films include, but are not limited to, fresh foods, frozen foods, shelf stable foods, medications, pharmaceuticals, nutraceuticals, supplements, cosmetics, pet foods, chemicals, medical devices, shampoo, cleaners, baby wipes and any other products typically packaged in high performance packaging.

### EXAMPLES

The following are prophetic examples of high-barrier recyclable films. These examples are not to be construed as limiting high-barrier recyclable film embodiments described herein in any way.

A film having a 3-layer structure of HDPE-LDPE/MDPE/HDPE-LDPE is coextruded using a blown film process. HDPE-LDPE is a blend of the two components. The film is produced with a thickness of 6.25 mils (158.8 microns). The blown film is then subjected to an electron beam unit, exposing it to 9 Mrad and labeled as film A. Film B is the same blown film, but has not been subjected to a cross-linking process.

Film A is stretched and annealed using an MDO process run with a stretch ratio of about 5:1. The films are corona treated on one side and the final film thickness (post MDO) is 1.25 mils (31.75 microns), resulting in base film A. Film B is similarly stretched, annealed and corona treated, resulting in base film B. Base film A and base film B are represented by the base film 110 shown in FIG. 3, having an outer layer 116 comprising a HDPE-LDPE blend, and inner layer 118 comprising a HDPE-LDPE blend and a single interior layer 117 comprising MDPE. Additionally, the blown film used to produce base films A and B contains various additives (i.e. slip, antiblock and process aid) as is common for packaging films. The additives account for less than 1% of the base film and the basis weight of the polyethylene content and non-polyethylene content is shown in Table 1.

Base films A and B are coated with a primer on the surface of the base film which has been corona treated. Then a clear barrier material is added. Approximately 0.8 g/m² (dry weight) of a polyacrylate based barrier material is applied to the base films. Finally, printed indicia (ink) is applied to the surface of the barrier material using a flexogravure printing process. The basis weight of the primer, barrier material and ink are shown in Table 1.

The next processing step is adhesive lamination. Base films A and B are each laminated to a 3.5 mil (88.9 micron) blown film sealant film with structure LLDPE/HDPE/mLLDPE producing high-barrier recyclable films A and B, respectively. The adhesive adheres the barrier material side of the base films to the LLDPE side of the sealant film. Again, the sealant film is mostly polyethylene, but does contain small amounts of non-polyethylene additives, as shown in Table 1.

The finished structures of high-barrier recyclable film A and B are represented by the high-barrier recyclable film 100 shown in FIG. 2. The base film 110 is coated with primer 150 followed with barrier material 130, printed with ink 140 and laminated with adhesive 160 to a sealant 120. The polyethylene and non-polyethylene portions of these structures is shown for each component in Table 1. Overall, the final structures of high-barrier recyclable films A and B contain over 97% polyethylene and are suitable for recycling.

TABLE 1
Example Films

| | Overall Basis | | Non-PE Basis |
|---|---|---|---|
| Component | Weight | PE Basis Weight | Weight |
| Base Film | 28.7 g/m² | 28.67 g/m² | 0.03 g/m² |
| Primer | 0.25 g/m² | 0 g/m² | 0.25 g/m² |
| Barrier Material | 0.8 g/m² | 0 g/m² | 0.8 g/m² |
| Ink (Indicia) | 0.2 g/m² | 0 g/m² | 0.2 g/m² |
| Adhesive | 1.6 g/m² | 0 g/m² | 1.6 g/m² |
| Sealant | 80.4 g/m² | 80.1 g/m² | 0.3 g/m² |
| Total | 111.95 g/m² | 108.77 g/m² (97.2%) | 3.18 Wm² |

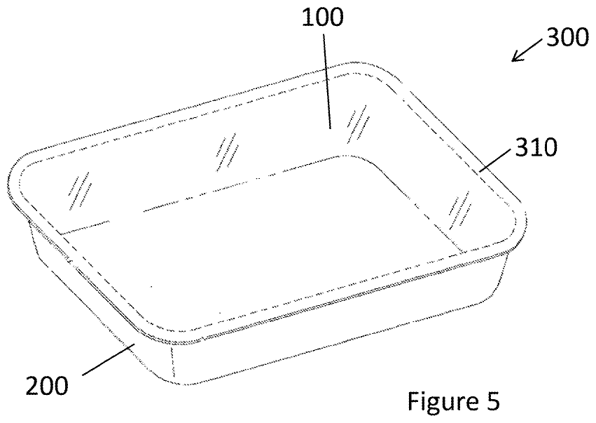

Films such as high-barrier recyclable films A and B would have the performance properties of a high oxygen barrier packaging film, yet be recyclable in the polyethylene recycling stream. This film could be used in a packaging application requiring high-barrier, such as in the lid 100 heat sealed to the tray 200 by heat seals 310 in the package 300 shown in FIG. 5.

### NON-LIMITING EMBODIMENTS

A. A high-barrier recyclable film comprising:
a. a base film, the base film being oriented, annealed and cross-linked,
b. a sealant, and
c. a barrier material, the barrier material located between the base film and the sealant,

wherein the high-barrier recyclable film comprises at least 95% polyethylene.

B. A high-barrier recyclable film according to any other high barrier recyclable film embodiment wherein the base film has a free shrink rate of less than 7% in the machine direction and less than 7% in the transverse direction upon application of heat up to 90° C.
C. A high-barrier recyclable film according to any other high barrier recyclable film embodiment, wherein the high-barrier recyclable film has an oxygen transmission rate between about 1×10⁻⁶ cm³/m²/24 hours to about 20 cm³/m²/24 hours.
D. A high-barrier recyclable film according to any other high barrier recyclable film embodiment, wherein the barrier material is polyacrylate based.
E. A high-barrier recyclable film according to any other high barrier recyclable film embodiment, wherein the barrier material is present at a basis weight between about 0.016 and about 3.26 g/m².
F. A high-barrier recyclable film according to any other high barrier recyclable film embodiment, wherein the high-barrier recyclable film comprises at least 97% polyethylene.
G. A high-barrier recyclable film according to any other high barrier recyclable film embodiment wherein the base film has a clarity of at least 85%.
H. A high-barrier recyclable film according to any other high barrier recyclable film embodiment wherein the at least 95% polyethylene portion of the base film composition consists of high-density polyethylene, medium-density polyethylene, low-density polyethylene, linear low-density polyethylene, or combinations thereof.
I. A high-barrier recyclable film according to any other high barrier recyclable film embodiment wherein the base film is coextruded and comprises an interior layer comprising medium-density polyethylene, the interior layer positioned between an outer layer comprising high-density polyethylene and an inner layer comprising high-density polyethylene.
J. A high-barrier recyclable film according to any other high barrier recyclable film embodiment further comprising printed indicia.
K. A high-barrier recyclable film comprising:
a. a base film,
b. a sealant film, and
c. a polyacrylate based barrier material located between the base film and the sealant film,
   wherein the base film has a free shrink rate of less than 7% in the machine direction and a free shrink rate of less than 7% in the transverse direction upon application of heat up to 90° C., and
   wherein the high-barrier recyclable film comprises at least 95% polyethylene.
      L. A high-barrier recyclable film according to any other high barrier recyclable film embodiment, wherein the base film is oriented in at least the machine direction.
      M. A high-barrier recyclable film according to any other high barrier recyclable film embodiment, further comprising an adhesive between the base film and the sealant film.
      N. A high-barrier recyclable film according to any other high barrier recyclable film embodiment, further comprising a primer between the base film and the sealant film.
      O. A high-barrier recyclable film according to any other high barrier recyclable film embodiment, wherein the high-barrier recyclable film has an oxygen transmission rate between about 1×10⁻⁶ cm³/m²/24 hours to about 20 cm³/m²/24 hours.
      P. A high-barrier recyclable film according to any other high barrier recyclable film embodiment, wherein the barrier material is in a layer that has basis weight between about 0.016 and about 3.26 g/m².
      Q. A package for a product comprising the high-barrier recyclable film according to any of embodiments A through P.
      R. A method of making a recyclable package, the method comprising:

extruding a polyethylene to form a base film;

orienting the base film in a machine direction;

annealing the base film;

coating the base film with a barrier material;

creating a high-barrier recyclable film by connecting the base film to a sealant such that the barrier material is between the base film and the sealant; and

forming the recyclable package by heat sealing the high-barrier recyclable film.

S. A method of making a recyclable package according to embodiment R wherein the method further includes irradiating the base film, thereby forming cross-links in at least an outer surface of the base film.
T. A high-barrier recyclable film comprising:
a. a base film that is oriented in at least one direction,
b. a sealant film, and
c. a barrier material located between the base film and the sealant film,

wherein the base film has a free shrink rate of less than 7% in the machine direction and a free shrink rate of less than 7% in the transverse direction upon application of heat up to 90° C., and

wherein the high-barrier recyclable film comprises at least 95% polyethylene.

What is claimed is:

1) A high-barrier recyclable film comprising:
a) a base film, the base film being oriented, annealed and cross-linked,
b) a sealant, and
c) a barrier material, the barrier material located between the base film and the sealant, wherein the high-barrier recyclable film comprises at least 95% polyethylene.

2) A high-barrier recyclable film according to claim 1, wherein the base film has a free shrink rate of less than 7% in the machine direction and less than 7% in the transverse direction upon application of heat up to 90° C.

3) A high-barrier recyclable film according to claim 1, wherein the high-barrier recyclable film has an oxygen transmission rate between about 1×10⁻⁶ cm³/m²/24 hours to about 20 cm³/m²/24 hours.

4) A high-barrier recyclable film according to claim 1, wherein the barrier material is polyacrylate based.

5) A high-barrier recyclable film according to claim 1, wherein the barrier material is present at a basis weight between about 0.016 g/m² and about 3.26 g/m².

6) A high-barrier recyclable film according to claim 1, wherein the high-barrier recyclable film comprises at least 97% polyethylene.

7) A high-barrier recyclable film according to claim 1, wherein the base film has a clarity of at least 85%.

8) A high-barrier recyclable film according to claim 1, wherein the at least 95% polyethylene portion of the base film composition consists of high-density polyethylene, medium-density polyethylene, low-density polyethylene, linear low-density polyethylene, or combinations thereof.

9) A high-barrier recyclable film according to claim 1, wherein the base film is coextruded and comprises an interior layer comprising medium-density polyethylene, the interior layer positioned between an outer layer comprising high-density polyethylene and an inner layer comprising high-density polyethylene.

10) A high-barrier recyclable film according to claim 1, further comprising printed indicia.

11) A high-barrier recyclable film comprising:
a) a base film,
b) a sealant film, and
c) a polyacrylate based barrier material located between the base film and the sealant film,
wherein the base film has a free shrink rate of less than 7% in the machine direction and a free shrink rate of less than 7% in the transverse direction upon application of heat up to 90° C., and
wherein the high-barrier recyclable film comprises at least 95% polyethylene.

12) A high-barrier recyclable film according to claim 11, wherein the base film is oriented in at least the machine direction.

13) A high-barrier recyclable film according to claim 11, further comprising an adhesive between the base film and the sealant film.

14) A high-barrier recyclable film according to claim 11, further comprising a primer between the base film and the sealant film.

15) A high-barrier recyclable film according to claim 11, wherein the high-barrier recyclable film has an oxygen transmission rate between about 1×10-6 cm³/m²/24 hours to about 20 cm³/m²/24 hours.

16) A high-barrier recyclable film according to claim 11, wherein the barrier material is in a layer that has basis weight between about 0.016 g/m² and about 3.26 g/m².

17) A package for a product comprising the high-barrier recyclable film according to claim 1 or 11.

18) A method of making a recyclable package, the method comprising:
a) extruding a polyethylene to form a base film;
b) orienting the base film in a machine direction;
c) annealing the base film;
d) coating the base film with a barrier material;
e) creating a high-barrier recyclable film by connecting the base film to a sealant such that the barrier material is between the base film and the sealant; and
f) forming the recyclable package by heat sealing the high-barrier recyclable film.

19) A method of making a recyclable package according to claim 18, wherein the method further includes irradiating the base film, thereby forming cross-links in at least an outer surface of the base film.

20) A high-barrier recyclable film comprising:
a) a base film that is oriented in at least one direction,
b) a sealant film, and
c) a barrier material located between the base film and the sealant film,
wherein the base film has a free shrink rate of less than 7% in the machine direction and a free shrink rate of less than 7% in the transverse direction upon application of heat up to 90° C., and
wherein the high-barrier recyclable film comprises at least 95% polyethylene.
